(19) United States
(12) Patent Application Publication
(10) Pub. No.: US 2025/0230869 A1
(43) Pub. Date: Jul. 17, 2025

(54) PLANET CARRIER FOR A REDUCTION GEAR OF AN AIRCRAFT TURBOMACHINE

(71) Applicant: SAFRAN TRANSMISSION SYSTEMS, Colombes (FR)

(72) Inventors: Quentin Pierre Henri PIGOTT, MOISSY-CRAMAYEL (FR); Guillaume Pierre MOULY, MOISSY-CRAMAYEL (FR)

(73) Assignee: SAFRAN TRANSMISSION SYSTEMS, Colombes (FR)

(21) Appl. No.: 18/730,718

(22) PCT Filed: Jan. 20, 2023
(86) PCT No.: PCT/FR2023/050082

§ 371 Date: Jul. 19, 2024

(30) Foreign Application Priority Data
Jan. 27, 2022 (FR) FR2200689

(51) Int. Cl. F16H 57/08; F02C 7/36; F16H 1/28

(52) U.S. Cl. CPC F16H 57/082; F02C 7/36; F16H 1/28; F05D 2260/40311

(57) ABSTRACT

A planet carrier for a reduction gear of a turbomachine includes a carrier frame having at its periphery axial housings distributed about the axis, a carrier frame holder with axial fingers distributed about the axis and engaged in the axial housings, and connecting elements connecting the fingers to walls of said housings. Each of the connecting elements has a pivot extending in a radial direction relative to the axis, and being borne by one of the members and having an external surface which in axial section has a convex shape and which collaborates with a cylindrical internal surface of an orifice of the other of these members.

### TECHNICAL FIELD OF THE INVENTION

The present invention relates to a planet carrier for a reduction gear of an aircraft turbomachine, as well as a reduction gear for an aircraft turbomachine.

### TECHNICAL BACKGROUND

The prior art comprises in particular the documents FR-A1-2 987 416, FR-A1-2 853 382, FR-A1-3 041 054, FR-A1-3 052 213, FR-A1-3 073 915, FR-A1-3 084 428.

The role of a mechanical reduction gear is to modify the gear ratio and the torque between the input axle and the output axle of a mechanism. The new generations of dual flow turbomachines, in particular those with a high bypass ratio, comprise a mechanical reduction gear to drive the shaft of a fan. The usual purpose of the reduction gear is to convert the rotational speed referred to as high speed of the shaft of a power turbine into a slower rotational speed for the shaft driving the fan.

Such a reduction gear comprises a central pinion, referred to as sun gear, a ring gear and pinions referred to as planet gears, which are engaged between the sun gear and the ring gear. The planet gears are maintained by a frame referred to as planet carrier. The sun gear, the ring gear and the planet carrier are planetary because their axes of revolution coincide with the longitudinal axis of the turbomachine. The planet gears each have a different axis of revolution and are equally distributed on the same operating diameter around the axis of the planetaries. These axes are parallel to the longitudinal axis of the turbomachine.

There are several reduction gear architectures. In the prior art of the dual flow turbomachines, the reduction gears are of the planetary or epicyclic type. In other similar applications, there are architectures referred to as differential or “compound”.
on a planetary reduction gear, the planet carrier is stationary and the ring gear is the output shaft of the device which rotates in the opposite direction of the sun gear.
in an epicyclic reduction gear, the ring gear is stationary and the planet carrier is the output shaft of the device which rotates in the same direction as the sun gear.
on a compound reduction gear, no element is attached in rotation. The ring gear rotates in the opposite direction of the sun gear and of the planet carrier.

The reduction gears can consist of one or more meshing stages. This meshing is ensured in different ways such as by contact, friction or by magnetic field. There are several types of meshing by contact such as straight or herringbone toothings.

The planet carrier may be a one-piece or may be in the form of a carrier frame and a carrier frame holder. The carrier frame comprises an internal cavity in which the sun gear, the planet gears and the guide bearings of these planet gears are housed. The sun gear comprises internal splines for coupling to a first shaft of the turbomachine and the carrier frame holder comprises a cylindrical portion comprising external splines for coupling to another shaft. The connection of the carrier frame to the carrier frame holder is usually rigid. Alternatively, a technology can be envisaged in which the carrier frame is connected to the carrier frame holder by “flexible” connections, as described in the document FR-A1-2 853 382. In such a case, the carrier frame holder comprises an annular row of axial fingers which are engaged in axial housings of the carrier frame and which are connected to walls of these housings by connecting elements which allow at least one degree of freedom of the finger in the housing.

There are two types of flexible connection for this application, the ball-and-socket joint and the sliding pivot joint.

In the case of a flexible ball-and-socket joint, each finger carries a ball through which a cylindrical pin extends into the housing of the carrier frame. The flexible connection is therefore a ball-and-socket connection between the carrier frame and the carrier frame holder, and more specifically between the fingers in their housings.

In the case of a flexible connection with a sliding pivot, each finger is traversed by a pivot extending into the housing of the carrier frame. The flexible connection is a sliding connection between the carrier frame and the carrier frame holder, and more specifically the fingers in their housings, in radial directions relative to the axis of the reduction gear.

During operation, when the planet carrier is torqued, the fingers will flex and transmit the torque to the carrier frame. The flexible connections ensure that the flexing of the fingers is not transmitted to the carrier frame. The carrier frame holder maintains the carrier frame in its plane of symmetry to balance the recovery of forces on both sides of the planet gears.

The present invention relates more particularly to flexible connections with a sliding pivot between a carrier frame and a carrier frame holder. In the present technique, the pivot comprises a perfectly cylindrical external surface which co-operates with a perfectly cylindrical internal surface of an orifice in the finger and which is slidable in a radial direction in this orifice. This sliding is made possible by the presence of a small but controlled clearance between the cylindrical surfaces of the pivot and the orifice.

During operation, significant forces are transmitted via these links along the axis of each pivot, generating misalignments between the carrier frame and the carrier frame holder. These misalignments cause a significant increase in the contact pressure between the pivots and the internal surfaces of the orifices, which is mainly concentrated at one end of each pivot.

The present invention offers an improvement that provides a simple, effective and economical solution to this problem.

### SUMMARY OF THE INVENTION

The invention relates to a planet carrier for a reduction gear of a turbomachine, particularly an aircraft turbomachine, the reduction gear having a main axis and comprising:
a carrier frame comprising an internal cavity configured to receive a sun gear centred on said axis and planet gears arranged around the axis and meshing with the sun gear as well as with a ring gear intended to surround the carrier frame, the carrier frame comprising at its periphery axial housings distributed around said axis,
a carrier frame holder comprising axial fingers distributed around the axis and engaged in said axial housings, and
connecting elements connecting said fingers to walls of said housings, each of these connecting elements comprising a pivot extending in a radial direction with respect to said axis, this pivot being carried by one of the members chosen from the finger and at least one of the walls and being capable of sliding along this radial direction in an orifice of the other of these members,
   characterised in that:
the pivot comprises an external surface which has a convex, preferably rounded, shape in axial section and which cooperates with a cylindrical internal surface of said orifice, or
the orifice comprises an internal surface which has a convex, preferably rounded, shape in axial section and which cooperates with a cylindrical external surface of said pivot.

The present invention therefore concerns two configurations. In the first configuration, the external surface of each of the pivots is therefore “domed” and the apex or crest of this surface is the preferred point of support on the internal surface of the corresponding orifice. This allows the area of contact pressure application to be moved from one of the axial ends of the pivot to the level of this apex or crest and, for example, to the middle of the external surface. The contact task is not located at one end of the pivot, and there is no risk of it being truncated, which could lead to poor distribution of contact pressure and stress concentrations. The solution therefore limits the level of contact pressure in the sliding-pivot connections of a planet carrier that May be subject to misalignment between its carrier frame and carrier frame holder.

Alternatively, and according to the second configuration, it is the internal surface of the orifice that is “domed”. The function and advantages of this configuration are the same as those described above.

The present invention is compatible with
a single or multi-stage reduction gear;
a planetary, epicyclic or compound reduction gear; and
of straight, helical or herringbone toothings.
all types of bearings for planet gears, whether rolling bearings, hydrodynamic bearings, etc.

The planet carrier according to the invention may comprise one or more of the following characteristics, taken alone from each other, or in combination with each other:
the external surface of the pivot or the internal surface of the orifice has a radius of curvature which is greater than 100 times an axial dimension of this surface;
the external surface of the pivot or the internal surface of the orifice has a radius of curvature which is greater than 50 times an average diameter of this surface;
said external surface of the pivot has an axial dimension which is equal to an axial dimension of said internal surface of the orifice and/or to an axial distance of engagement of the pivot in the orifice;
the pivot is carried by the carrier frame, and the orifice is formed in the finger of the carrier frame holder;
the finger is inserted between two walls of the housing, the pivot passing through the orifice of the finger and being mounted in holes in these walls;
the holes in the walls have different diameters;
the pivot comprises at least two coaxial segments of different diameters, said external surface being located on one of these segments;
the pivot comprises three adjacent segments, at least some of which have different diameters;
said external surface is located on one of the intermediate diameter segments, which is located between a smaller diameter segment and a larger diameter segment.

This invention also relates to a mechanical reduction gear for an aircraft turbomachine, comprising a planet carrier according to one of the preceding claims, a sun gear mounted in said cavity and centred on said axis, a ring gear extending around the sun gear, and planet gears mounted in said cavity and meshed with the sun gear and the ring gear.

The invention further relates to a turbomachine, in particular for an aircraft, comprising a reduction gear as described above.

### BRIEF DESCRIPTION OF THE FIGURES

Further characteristics and advantages will be apparent from the following description of a non-limiting embodiment of the invention with reference to the appended drawings in which:

FIG. 1 is a schematic axial cross-sectional view of a turbomachine using the invention;

FIG. 2 is a schematic view of a reduction gear with epicyclic gear train in axial cross-section;

FIG. 3 is a perspective view of a carrier frame of a reduction gear planet carrier;

FIG. 4 is an axial sectional view of the carrier frame in FIG. 3 and a carrier frame holder, the carrier frame and carrier frame holder forming a reduction gear planet carrier and being connected by flexible ball-and-socket joints;

FIG. 5 is a detail view of FIG. 4;

FIG. 6 is an exploded perspective view of a carrier frame and carrier frame holder assembly forming a reduction gear planet carrier, the carrier frame and carrier frame holder being connected by flexible sliding pivot links;

FIG. 7 is a partial axial cross-sectional view of a part of the planet carrier of FIG. 6;

FIG. 8 is a detail view of FIG. 7;

FIG. 9 is a larger-scale schematic view of a detail of FIG. 7 and illustrates the present invention.

### DETAILED DESCRIPTION OF THE INVENTION

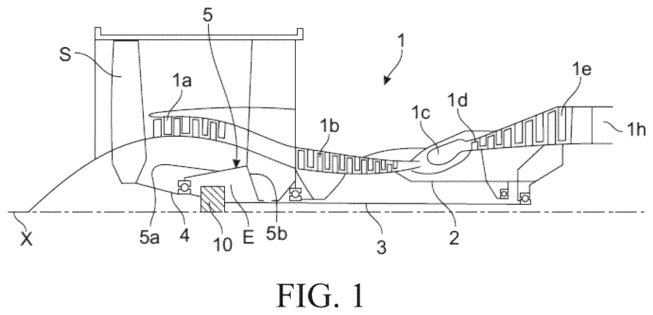

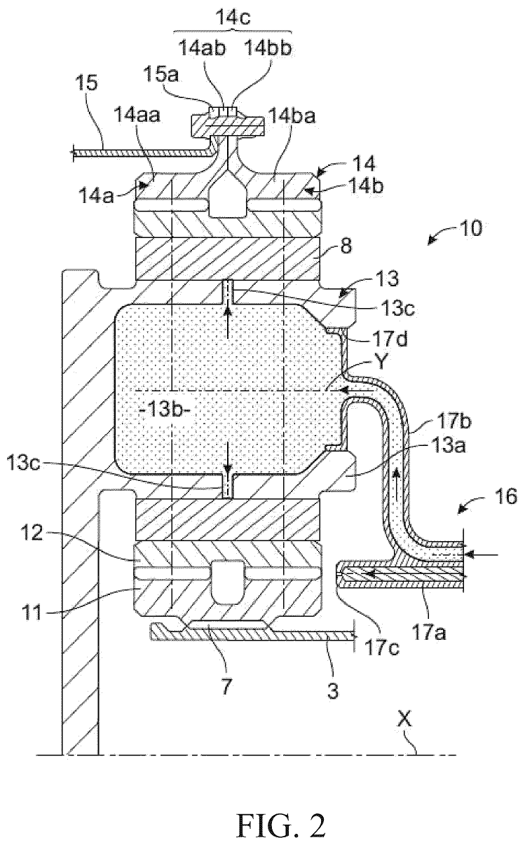

FIG. 1 describes a turbomachine 1 which conventionally comprises a fan S, a low-pressure compressor 1a, a high-pressure compressor 1b, an annular combustion chamber 1c, a high-pressure turbine 1d, a low-pressure turbine 1e and an exhaust nozzle 1h. The high-pressure compressor 1b and the high-pressure turbine 1d are connected by a high-pressure shaft 2 and together they form a high-pressure (HP) body. The low-pressure compressor 1a and the low-pressure turbine 1e are connected by a low-pressure shaft 3 and together they form a low-pressure (LP) body.

The fan S is driven by a fan shaft 4 which is connected to the LP shaft 3 by means of a reduction gear 10. This reduction gear is usually of the planetary or epicyclic type.

Although the following description concerns a reduction gear with planetary or epicyclic type, it also applies to a mechanical differential in which its three essential components, that are the planet carrier, the ring gear and the sun gear, can be rotatable, the rotational speed of one of these components depending in particular on the difference in speed of the other two components.

The reduction gear 10 is positioned in the upstream portion of the turbomachine. A stationary structure comprising schematically, here, an upstream portion 5a and a downstream portion 5b which makes up the engine casing or stator 5 is arranged so as to form an enclosure E surrounding the reduction gear 10. This enclosure E is here closed upstream by seals at the level of a bearing allowing the passage of the fan shaft 4, and downstream by seals at the level of the passage of the LP shaft 3.

FIG. 1 shows a portion of a reduction gear 10 that can take the form of different architectures depending on whether certain parts are stationary or in rotation. The input of the reduction gear 10 is connected to the LP shaft 3, for example by means of splines 7. Thus the LP shaft 3 drives a planetary pinion referred to as the sun gear 11. Classically, the sun gear 11, whose axis of rotation is coincident with the axis X of the turbomachine 1, drives a series of pinions referred to as planet gears 12, which are equally spaced on the same diameter around the axis of rotation X. This diameter is equal to twice the operating centre distance between sun gear 11 and planet gears 12. The number of planet gears 12 is generally defined between three and seven for this type of application.

The assembly of the planet gears 12 is maintained by a chassis referred to as planet carrier 12. Each planet gear 12 rotates around its own axis Y, and meshes with the ring gear 14.

At the output of the reduction gear 10, we have:
in an epicyclic configuration, the assembly of the planet gears 12 drives the planet carrier 13 in rotation around the axis X of the turbomachine. The ring gear 14 is attached to the engine casing or stator 5 via a ring gear carrier 15 and the planet carrier 12 is attached to the fan shaft 4.
in a planetary configuration, the assembly of the planet gears 12 is maintained by a planet carrier 12 which is attached to the engine casing or stator 5. Each planet gear drives the ring gear which is fitted to the fan shaft 4 via a ring gear carrier 15.

Each planet gear 12 is mounted freely in rotation by means of a bearing 8, for example of the rolling or hydrostatic bearing type. Each bearing 8 is mounted on one of the axles 13a of the planet carrier 12, and all of the axles are positioned relative to each other using one or more structural chassis of the planet carrier 12. There is a number of axles and bearings equal to the number of planet gears. For reasons of operation, mounting, production, inspection, repair or replacement, the axles 13a and the chassis can be separated into several parts.

For the same reasons mentioned above, the toothing of a reduction gear can be separated into several propellers. In our example we detail the operation of a reduction gear 10 with several propellers with a ring gear separated into two half-ring gears:
A front half-ring gear 14a comprising a rim 14aa and an attachment half-flange 14ab. On the rim 14aa is the front propeller of the toothing of the reduction gear. This front propeller meshes with that of the planet gear 12 which meshes with that of the sun gear 11.
A rear half-ring gear 14b comprises a rim 14ba and an attachment half-flange 14bb. On the rim 14ba is the rear propeller of the toothing of the reduction gear. This rear propeller meshes with that of the planet gear 12 which meshes with that of the sun gear 11.

The attachment half-flange 14ab of the front ring gear 14a and the attachment half-flange 14bb of the rear ring gear 14b form the attachment flange 14c of the ring gear. The ring gear 14 is attached to the ring gear carrier 15 by assembling the attachment flange 14c of the ring gear and the attachment flange 15a of the ring gear carrier using a bolted mounting, for example. In the following, a half-flange may be referred to as a flange. The arrows in FIG. 1 describe the oil conveying in the reduction gear 10. The oil arrives in the reduction gear 10 from the stator portion 5 in the turbine stator vane 16 by different means which will not be specified in this view because they are specific to one or several types of architecture. The turbine stator vane 16 is separated into two parts, each of which is repeated by the same number of planet gears. The function of the injectors 17a is to lubricate the toothings, and the function of the arms 17b is to lubricate the bearings 8. The oil is fed towards the injector 17a to emerge through the end 17c to lubricate the toothings. The oil is also fed towards each arm 17b and circulates through the feed mouth 17d of the bearing 8. The oil then circulates through the axis 13a into one or more buffer areas 13b and then emerges through orifices 13c to lubricate the bearings 8 of the planet gears.

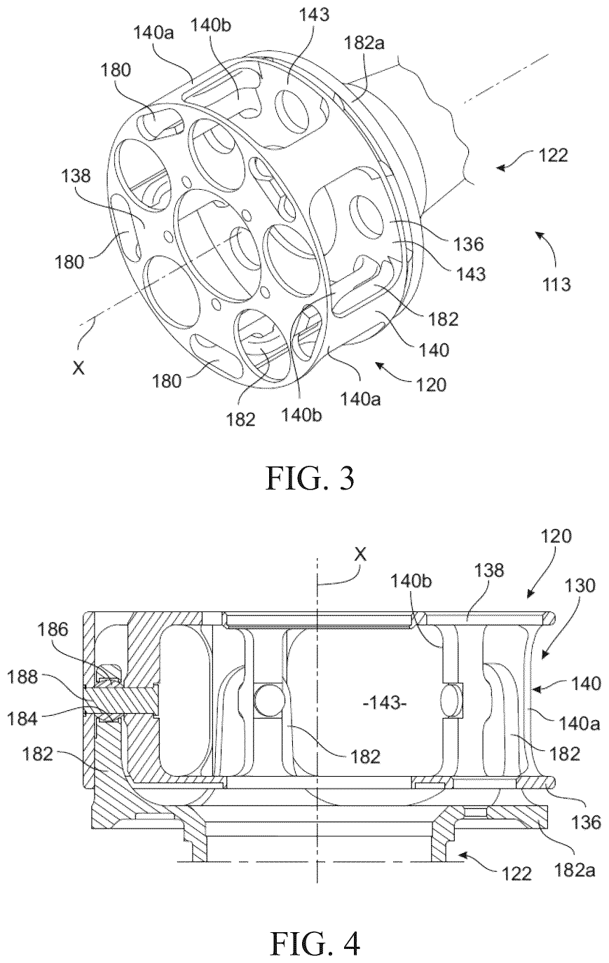

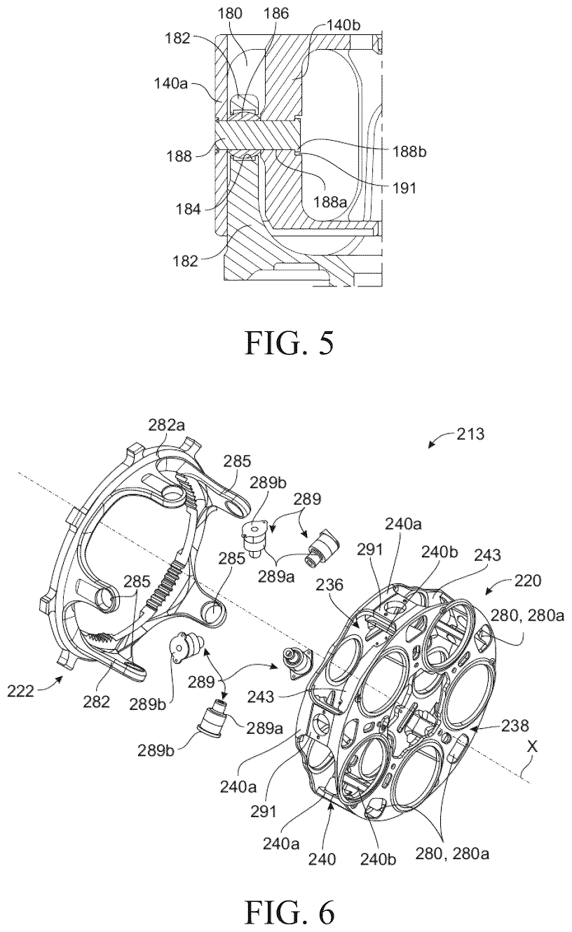

In FIGS. 3 to 5, the elements already described above are designated by the same references increased by one hundred.

FIGS. 3 to 5 show a particular technology of planet carrier 113, this planet carrier comprising a carrier frame 120 and a carrier frame holder 122 connected by “flexible” ball-and-socket joints.

The carrier frame 120 comprises two radial annular walls 136, 138 that are parallel to each other and perpendicular to the axis X, and a cylindrical wall 140 that extends between the external peripheries of these walls 136, 138. The cylindrical wall 140 is here of the double-skinned type and comprises an external skin 140a interrupted by openings 143 and an internal skin 140b interrupted by the same openings 143. The external skin 140a separated by five openings 143 forms five outer bridges and the internal skin 140b separated by five openings 143 forms five inner bridges. Each pair of lower and upper bridges forms a clevis to accommodate the finger 182 of the carrier frame holder 122. In other words, the bridges of each pair define between them a housing 180 for receiving a finger 182 of the carrier frame holder 122. The bridges ensure the structural connection between the walls 136 and 138. Elongated openings 180 are formed in at least one of the walls 136 and 138 so as to allow the finger 182 to pass between the inner and outer bridges. The carrier frame 120 thus comprises an annular row of housings 180. These housings 180 receive the axial fingers 182 secured to a substantially radial annular wall 182a of the carrier frame holder 122. The wall 182a is located at an axial end of the carrier frame holder 122. The fingers 182 extend axially from the wall 182a and are engaged by axial translation into the housings 180.

Each finger 182 comprises, substantially in its middle, a mounting ring 184 of the ball joint 186 intended to be passed through by a cylindrical pin 188 carried by the carrier frame 120.

The ring 184 has a substantially radial orientation with respect to the axis X. It has a generally cylindrical shape. The carrier frame 120 and the ball joint 186 have a thickness, measured in a radial direction with respect to the axis X, which is less than the inter-bridges distance or the radial thickness of the oblong opening 180, so that they can be engaged in this housing concomitantly with the finger 182 supporting these pieces.

Each housing 180 is passed through by a pin 188 which has a substantially radial orientation with respect to the axis X. Each pin 188 comprises a cylindrical body 188a connected at an axial end, here radially internal, to an external annular collar 188b. The pin 188 is here engaged by radial translation from the inside through the radial orifices of the bridges, its collar 188b being intended to come to be radially supported on a flat face 191 of the outer bridge of the carrier frame 120. After insertion of the pin 188 into the orifices of the bridges, until the collar 188b is in contact with the outer bridge, the collar 188b is attached to this bridge, for example by screwing.

In FIGS. 6 to 9, the elements already described above are designated by the same references increased by another hundred.

FIGS. 6 to 9 show a particular technology of planet carrier 213, this planet carrier comprising a carrier frame 220 and a carrier frame holder 222 connected by “flexible” sliding pivot links.

The carrier frame 220 comprises two radial annular walls 236, 238 that are parallel to each other and perpendicular to the axis X, and a cylindrical wall 240 that extends between the external peripheries of these walls 236, 238. The walls 236, 238 and 240 define between them a cavity for receiving the sun gear and the planet gears of the reduction gear.

The cylindrical wall 240 is double-skinned and comprises an external skin 240a interrupted by the openings 243 and an internal skin 240b interrupted by the same openings 243. The outer skin 240a separated by five openings 243 forms five outer bridges and the inner skin 240b separated by five openings 243 forms five inner bridges.

The openings 243 are designed to be passed through by the planet gears housed in the cavity of the planet carriers, allowing them to mesh with the ring gear of the reduction gear.

Each pair of lower and upper bridges forms a clevis to receive the finger 282 of the carrier frame holder 222. In other words, the bridges of each pair define between them a housing 280 for receiving a finger 282 of the carrier frame holder 222. The bridges ensure the structural connection between the walls 236 and 238. Oblong openings 280a are formed in at least one of the walls 236 and 238 to allow the finger 282 to pass between the inner and outer bridges.

The carrier frame 220 thus comprises an annular row of housings 280. These housings 280 receive the axial fingers 282 secured to a substantially radial annular wall 282a of the carrier frame holder 222. The wall 282a is located at one axial end of the carrier frame holder 222. The fingers 282 extend axially from the wall 282a and are engaged by axial translation in the housings 280.

Each finger 282 comprises an orifice 285 designed to be passed through by a pivot 289 carried by the carrier frame 220.

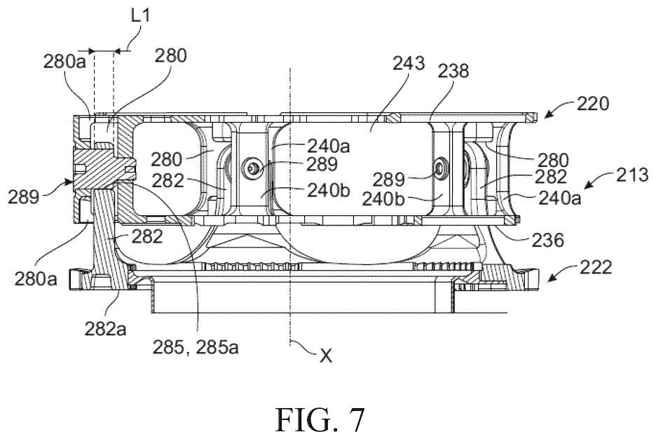

Each orifice 285 has a substantially radial orientation with respect to the axis X and comprises an internal surface 285a which is cylindrical. The main axis of the orifice 285 is denoted A and is therefore oriented radially with respect to axis X. The finger 282 has a thickness, measured along this axis A, which is less than the inter-tap distance or the radial thickness of the oblong opening 280a, so that it can be engaged in this housing 280. The orifice 285 and its surface 285a have a length L1 measured along this axis A (see FIG. 7).

Each housing 280 is traversed by a pivot 289 which has a radial orientation with respect to the axis X and which extends along an axis A. Each pivot 289 comprises a body 289a connected at an axial end, here radially external, to an external annular collar 289b. The pivot 289 is engaged by radial translation from the outside through radial holes 290, 292 in the bridges, its collar 289b being designed to bear radially against a flat face 291 of the outer bridge of the carrier frame 220. After the pivot 289 has been inserted into the holes 290, 292 in the bridges, until the collar 289b rests on the outer bridge, the collar 289b is fixed to this bridge, for example by screwing.

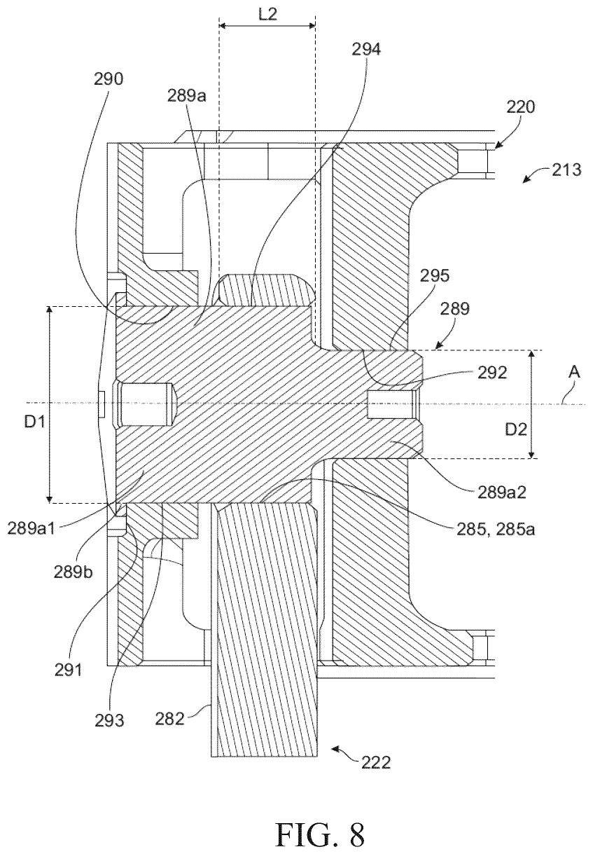

The hole 290 in the outer bridge has a diameter D1 and the hole 292 in the inner bridge has a diameter D2 which is smaller than D1 (see FIG. 8). The pivot 289, and in particular its body 289a, comprises two adjacent segments 289a1, 289a2 of different diameters. The smallest diameter segment 289a2 is inserted into the hole 292 and therefore has a diameter equal to or close to D2. The larger diameter segment 289a1 is located between the collar 289b and the segment 289a2 and comprises two parts. A first part of the segment 289a1 located on the side of the collar 289b is engaged in the hole 290 and therefore has a diameter equal to or close to D1. A second part of the segment 289a1 located on the side of the segment 289a1, and more particularly between the first part of the segment 289a1 and this segment 289a2, is engaged in the orifice 285 of the finger 282.

Alternatively, it could be considered that the pivot 289, and in particular its body 289a, comprises three adjacent segments, the segment 289a1 in fact forming two segments where the external surfaces 293 and 294 are located. The segment comprising the surface 293 may have a larger diameter than the segment comprising the surface 294. The surface 293 is then located on the segment of intermediate diameter, which is located between the segment 289a2 of smaller diameter and the segment with the surface 293 of larger diameter.

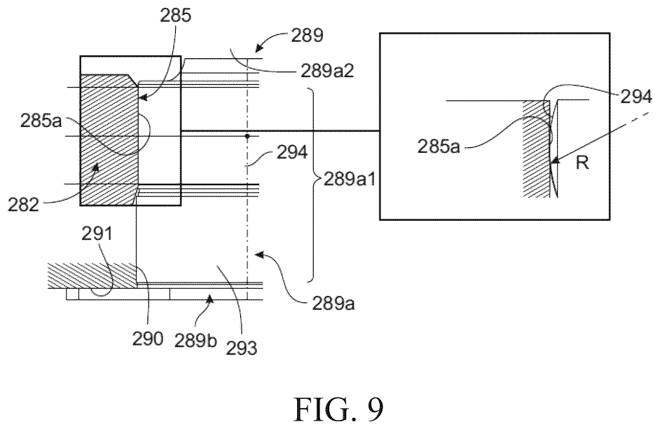

The external surfaces 293, 295 of the segment 289a2 and of the first part of the segment 289a1 are cylindrical. In contrast, the external surface 294 of the second part of the segment 289a1 has a convex, preferably rounded shape in axial section (see the enlarged view on the right of FIG. 9). Other convex shapes are possible, such as elliptical, logarithmic, etc.

The external surface 294 has an axial length or dimension L2 measured along the axis A. In the example shown, the axial distance of engagement of the pivot 289 in the orifice 285 is substantially equal to L2 which is substantially equal to L1.

The external surface 294 advantageously has a relatively large radius of curvature R so as to have the largest possible contact surfaces between the pivot 289 and the finger 282, while distributing the bearing pressures on these contact surfaces in a controlled manner. This radius of curvature R is measured in a plane passing through the axis A.

Preferably, the external surface 294 has a radius of curvature R which is greater than 100 times an axial dimension L2 of this surface.

Alternatively or additionally, the external surface 294 has a radius of curvature R which is greater than 50 times an average diameter D1 of this surface.

In a variant of the invention not shown, the pivots 289 could be carried by the carrier frame holder 222 instead of by the carrier frame 220. The fingers 282 through which these pivots 289 pass would then be carried by the carrier frame 220 and no longer by the carrier frame holder 222 as in the aforementioned case. The carrier frame holder 222 would then contain the housings 280 for receiving these fingers 282.

In yet another variant not shown, the “domed” surface would be the internal surface 285a of the orifice 285 (instead of the external surface of the pivot) and the external surface 294 of the pivot 289 would then be cylindrical.

1. A planet carrier for a reduction gear of a turbomachine having a main axis, the planet carrier comprising:
a carrier frame comprising an internal cavity configured to receive a sun gear centered on said axis and planet gears arranged around the axis and meshing with the sun gear as well as with a ring gear configured to surround the carrier frame, the carrier frame comprising at a periphery axial housings distributed around said axis,
a carrier frame carrier comprising axial fingers distributed around the axis and engaged in said axial housings, and
connecting elements connecting said fingers to walls of said housings, each of the connecting elements comprising a pivot extending in a radial direction with respect to said axis, this pivot being carried by one of the members chosen from the finger and at least one of the walls and being configured to slide along this radial direction in an orifice of the other of these members,
wherein:
the pivot comprises an external surface which has a convex shape in axial section and which cooperates with a cylindrical internal surface of said orifice, or
the orifice comprises an internal surface which has a convex; shape in axial section and which cooperates with a cylindrical external surface of said pivot.

2. The planet carrier according to claim 1, wherein the external surface of the pivot or the internal surface of the orifice has a radius of curvature which is greater than 100 times an axial dimension of this surface.

3. The planet carrier according to claim 1, wherein the external surface of the pivot or the internal surface of the orifice has a radius of curvature which is greater than 50 times an average diameter (D1) of this surface.

4. The planet carrier according to claim 1, wherein said external surface of the pivot has an axial dimension (L2) which is equal to an axial dimension (L1) of said internal surface of the orifice and/or to an axial distance of engagement of the pivot in the orifice.

5. The planet carrier according to claim 1, wherein the pivot is carried by the carrier frame, and the orifice is formed in the finger of the carrier frame holder.

6. The planet carrier according to claim 5, wherein the finger is inserted between two walls of the housing, the pivot passing through the orifice of the finger and being mounted in holes in these walls.

7. The planet carrier according to claim 6, wherein the holes in the walls have different diameters.

8. The planet carrier according to claim 1, wherein the pivot comprises at least two coaxial segments of different diameters, said external surface being located on one of these segments.

9. The planet carrier according to claim 1, wherein the pivot comprises three adjacent segments, at least two of the adjacent segments having different diameters.

10. The planet carrier according to claim 1, wherein said external surface is located on an intermediate diameter segments, which is located between a smaller diameter segment and a larger diameter segment.

11. A mechanical reduction gear for an aircraft turbomachine, comprising the planet carrier according to claim 1, a sun gear mounted in said cavity and centered on said axis, a ring gear extending around the sun gear, and planet gears mounted in said cavity and meshed with the sun gear and the ring gear.

12. A turbomachine, comprising the reduction gear according to claim 11.
